(19) United States
(12) Patent Application Publication
(10) Pub. No.: US 2016/0190921 A1
(43) Pub. Date: Jun. 30, 2016

(54) SELECTABLE-MODE VOLTAGE REGULATOR TOPOLOGY

(71) Applicant: Intel Corporation, Santa Clara, CA (US)

(72) Inventors: Pavan Kumar, Portland, OR (US); Harish K. Krishnamurthy, Hillsboro, OR (US)

(73) Assignee: Intel Corporation, Santa Clara, CA (US)

(21) Appl. No.: 14/582,956

(22) Filed: Dec. 24, 2014

(51) Int. Cl. H02M 3/158

(52) U.S. Cl. CPC H02M 3/158

(57) ABSTRACT

One embodiment provides an apparatus. The apparatus includes a selectable-mode voltage regulator (VR) to implement one or more of a plurality of VR modes. The selectable-mode VR includes a plurality of switches, an inductor (L), a flying capacitor (Cf), and an output capacitor (Cout).

This invention was made with Government support under contract number FA8650-13-3-7338 awarded by the Department of Defense. The Government has certain rights in this invention.

### FIELD

The present disclosure relates to a voltage regulator topology, in particular to, a selectable-mode voltage regulator topology.

### BACKGROUND

Selection of a voltage regulator topology may be based, at least in part, on desired performance characteristics (e.g., conversion efficiency). For a given voltage regulator topology (e.g., buck, switched capacitor, low drop out (i.e., linear), etc.), the performance characteristics vary with voltage regulator operational characteristics, e.g., output voltage range and/or output (i.e., load) current range. Thus, a specific voltage regulator topology that exhibits desirable performance characteristics at a specific output voltage and/or load current may exhibit undesirable performance characteristics at another output voltage and/or load current. Design considerations may further include size (e.g., area and/or volume occupied by a voltage regulator topology) and cost.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a selectable-mode voltage regulator (VR) topology system consistent with various embodiments of the present disclosure;

FIG. 2 is a plot of switching node voltage (VSW) and output voltage (Vout) simulation results corresponding to the selectable-mode VR of FIG. 1 configured as a traditional (classic) buck VR;

FIG. 3 illustrates a VSW waveform for the selectable-mode VR of FIG. 1 configured as a 3-level buck VR;

FIG. 4 illustrates a Vout waveform for the selectable mode VR of FIG. 1 configured as a switched capacitor VR; and

FIG. 5 is a flowchart of selectable-mode voltage regulation operations according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a selectable-mode voltage regulator (VR) topology. A selectable-mode VR is configured to implement one or more of a plurality of VR modes, e.g., linear (e.g., low drop out), traditional (i.e., classic) buck, three-level buck and/or switched capacitor. A selectable-mode VR topology system and method are configured to allow selecting a specific VR prior to and/or during operation of the selectable-mode VR. The VR mode may be selected based, at least in part, on one or more load characteristic(s), including, but not limited to, anticipated load, existing load, a signal from a load device that includes a load, a sensed current and/or a sensed voltage. The specific VR mode may be selected to optimize one or more performance characteristics of the VR topology for existing and/or anticipated operating conditions. Performance characteristics may include, but are not limited to, conversion efficiency, output voltage ripple, output current ripple, transient performance, etc. Operating conditions may include, but are not limited to, load (i.e., output) voltage and/or load (i.e., output) current. If the operating conditions change, another VR mode may be selected and the selectable-mode VR may be reconfigured accordingly.

A selectable-mode VR (i.e., a selectable-mode VR topology), consistent with the present disclosure, is configured to implement the VR modes without requiring a plurality of individual, single mode VR topologies. Thus, the selectable-mode VR may be relatively lower cost and may occupy less area than a plurality of individual, single mode VR topologies. Further, the VR mode may be selected based, at least in part, on existing and/or anticipated operating conditions. Thus, selection of VR mode may be optimized for each of a plurality of operating conditions. In other words, a first VR mode may be selected initially then a second VR mode may be selected, for example, in response to a change in existing operating conditions and/or a notification of an anticipated change in operating conditions. The selections may be implemented via control of one or more switches included in the selectable-mode VR.

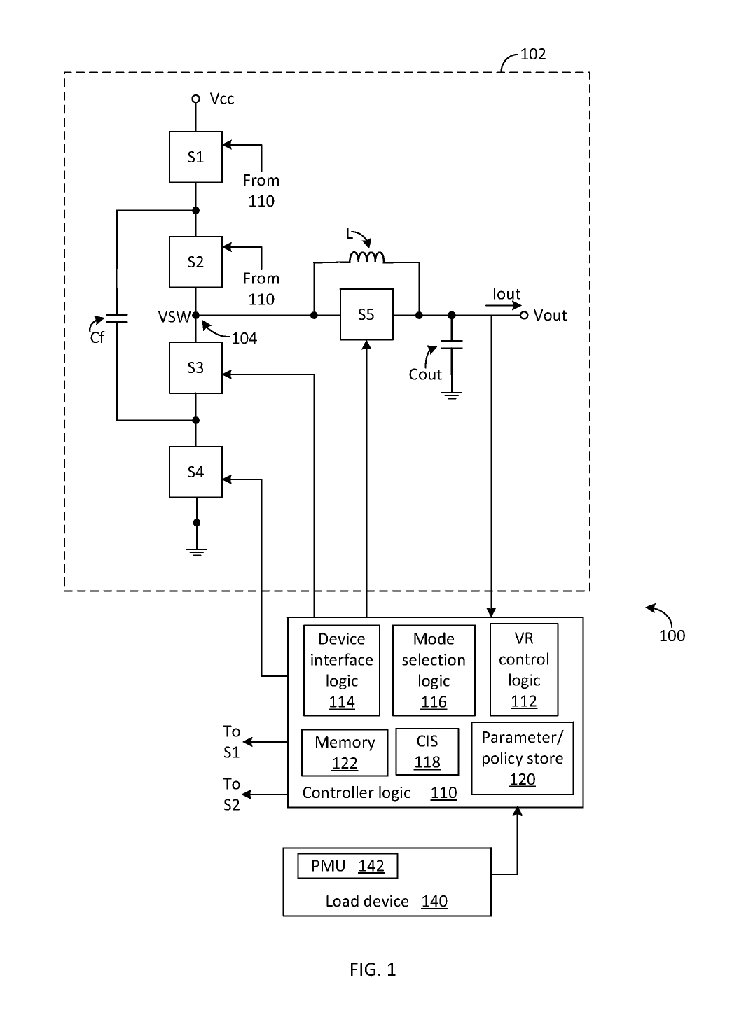

FIG. 1 illustrates a functional block diagram of a selectable-mode VR topology system 100 consistent with various embodiments of the present disclosure. System 100 includes a selectable-mode VR 102 and controller logic 110. The selectable-mode VR 102 includes a plurality of switches S1, S2, S3, S4, S5 that may be controlled by controller logic 110, as described herein.

System 100 may be coupled to a load device 140. Load device 140 may include, but is not limited to, a computing device (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer); a mobile telephone including, but not limited to a smart phone, (e.g., iPhone®, Android®-based phone, Blackberry®, Symbian®-based phone, Palm®-based phone, etc.) and/or a feature phone; a wearable device and/or system; and/or sensor(s) and/or a sensor network (wired and/or wireless), etc.

Load device 140 may be configured to receive energy (i.e., draw a load current at a load device 140 operating voltage) from selectable-mode VR 102. Load device 140 may be further configured to provide an indication to controller logic 110 related to existing and/or anticipated power requirements of load device 140. For example, load device 140 may include a performance monitoring unit (PMU) 142 configured to monitor performance of load device 140. Load device 140 may be configured to implement dynamic voltage and/or frequency scaling (DVFS) to manage power consumption of load device 140 based, at least in part, on one or more operational and/or idle states. Such power management may comply and/or be compatible with an Advanced Configuration and Power Interface (ACPI) specification, as described herein. Load device 140 may then provide a notification, e.g., an alert, to controller logic 110 related to existing power consumption and/or anticipated changes in power consumption of load device 140. For example, load device 140 may be configured to provide a load change alert to controller logic 110 when an element of load device 140, e.g., a processor and/or an operating system, is to transition from an idle state to an operational state. Such a transition may be associated with an increase in power consumption by load device 140. In another example, load device 140 may be configured to provide a load change alert to controller logic 110 when an element of load device 140 is to transition from an operational state to an idle state. Such a transition may be associated with a decrease in power consumption by load device 140.

Controller logic 110 is configured to manage operations of selectable-mode VR 102. For example, controller logic 110 may be configured to receive the alert from load device 140 related to power consumption of load device 140. Controller logic 110 may be configured to monitor one or more load characteristics, e.g., an output voltage Vout and/or output (i.e., load) current Tout of selectable-mode VR 102. Controller logic 110 may be configured to select a mode of selectable-mode VR 102 in response to the alert and/or based, at least in part, on detected Vout and/or detected Tout, as described herein.

Controller logic 110 includes VR control logic 112, device interface logic 114, mode selection logic 116, control input signal (CIS) logic 118 and a parameter and policy store 120. Device interface logic 114 is configured to receive alert(s) from load device 140. Device interface logic 114 may then store an associated alert indicator in parameter and policy store 120. Device interface logic 114 may provide the alert to mode selection logic 116. In some embodiments, controller logic 110 may include memory 122, e.g., configured to store parameter and policy store 120.

VR control logic 112 is configured to control operations of selectable-mode VR 102. VR control logic 112 is configured to monitor Vout and/or Tout and to adjust operation of selectable-mode VR 102 based, at least in part, on Vout and/or Tout. For example, operation of selectable mode VR 102 may be controlled and/or adjusted by controlling a respective state of one or more of switches S1, S2, S3, S4, S5, as will be described in more detail below.

Mode selection logic 116 is configured to select a VR mode of selectable-mode VR 102. VR modes may include, but are not limited to, linear (e.g., low drop out), traditional (i.e., classic) buck, three-level buck, switched capacitor and/or a combination, e.g., switched capacitor followed by linear (low drop out). Mode selection logic 116 may be configured to select the VR mode based, at least in part, on one or more load characteristics including, but not limited to sensed Vout, sensed Tout, an alert from load device 140. Mode selection logic 116 may be configured to select the VR mode based, at least in part, on a policy indicator stored in parameter and policy store 120. Mode selection logic 116 may be further configured select the VR mode, dynamically, during operation of selectable-mode VR 102. For example, mode selection logic 116 may select the VR mode in response to a change in Vout and/or Tout detected by, e.g., VR control logic 112. In another example, mode selection logic 116 may select the VR mode in response to a load change alert from load device 140. Selecting the VR mode in response to a load change alert may be performed in advance of the actual load change and may avoid a drop in Vout if the load change corresponds to an increase in power consumption by load device 140. In an embodiment, mode selection logic 116 may be configured to notify VR control logic 112 of a change in selected VR mode. In another embodiment, mode selection logic 116 may be configured to store and/or update a VR mode indicator in parameter and policy store 120 related to a current VR mode selection. VR control logic 112 may then be configured to control switches S1, S2, S3, S4, S5 based, at least in part, on the notice from mode selection logic 116 and/or the VR mode indicator.

Control input signal CIS logic 118 is configured to generate a control input signal that may be utilized to drive (i.e., control) one or more of switches S1, S2, S3, S4, S5. In an embodiment, the control input signal may correspond to a pulse width modulated (PWM) signal that includes a variable pulse width and a generally fixed frequency. In another embodiment, the control input signal may vary frequency, e.g., hysteresis mode, pulse skipping, etc. In another embodiment, the control input signal may vary pulse width (i.e., state interval duration) and/or frequency Fs. Thus, the control input signal may have a fixed and/or a variable frequency Fs and a corresponding period Ts=1/Fs. The control input signal may have a fixed and/or a variable duty cycle D. Each cycle (i.e., period Ts) of a PWM signal may include a pulse of pulse width τ. The pulse width τ may correspond to a state interval, as described herein. A ratio of τ to Ts may then correspond to the duty cycle D of the PWM signal. A range of duty cycle D may be 0 to 1, inclusive. Nominal values and/or ranges of values for frequency Fs, period Ts and/or duty cycle D may be stored in parameter and policy store 120. The values may be related to VR mode and/or physical characteristics of selectable-mode VR 102, e.g., whether selectable-mode VR 102 is implemented on-die and/or off-die, as described herein. The values may be related to a nominal Vout, a nominal Tout and/or operating ranges of Vout and/or Tout.

Allowable switching frequencies (i.e., Fs) may be related to whether the selectable-mode VR 102 and/or elements of selectable-mode VR 102 are implemented on-die, off-die or a combination. As used herein, on-die means included in an integrated circuit, e.g., fabricated in or on a silicon wafer and off-die means included on a printed circuit board (PCB). Off-die corresponds to on-platform. A selectable-mode VR 102 may be implemented on-die, off-die or a combination of on-die and off-die (i.e., on-die and/or off-die). For example, if the selectable-mode VR 102 is implemented on-die, Fs may be on the order of hundreds of megahertz (MHz). In another example, if the selectable-mode VR 102 is implemented off-die, Fs may be on the orders of hundreds of kilohertz (kHz) or ones of MHz.

Selection of switching frequency Fs may be further related to efficiency optimization, source voltage (Vcc) range, output voltage range, load current and/or relative values of output voltage Vout and source voltage Vcc. In a first example, for an on-die selectable-mode VR 102 configuration, supply voltage may be at or near 1.5 volts to 1.8 volts and an associated output voltage Vout may be less than or equal to 1.0 volt. Fs for this example, may be in the range of 100 MHz to 500 MHz or greater. In a second example, for an off-die selectable-mode VR 102 configuration, the supply voltage may be relatively high, e.g., 12 volts or 19 volts, and the output voltage Vout may be 1.0 volt Fs for this second example may be at or near 200 kHz. A duty cycle of a switch control input signal for the first example may be approximately ½ (i.e., 0.5) and the duty cycle for the second example may be approximately 1/12 (i.e., 0.08). Operating efficiency is related to switching losses which are related to switching frequency Fs and a ratio of output voltage to input voltage. Thus, based, at least in part, on efficiency, a relatively lower switching frequency may be used with a relatively higher voltage ratio and/or a relatively higher switching frequency may be used with a relatively lower voltage ratio.

Thus, controller logic 110 is configured to manage operations of selectable-mode VR 102. Controller logic 110 may be configured to receive alert(s) from load device 140, to monitor Vout and/or Iout, to select a mode of selectable-mode VR 102 in response to the alert and/or based, at least in part, on detected Vout and/or detected Tout. Controller logic 110 may be further configured to control switches S1, S2, S3, S4, S5, as described herein.

Selectable-mode VR 102 includes the plurality of switches S1, S2, S3, S4, S5, a fly (i.e., floating) capacitor Cf, an output capacitor Cout and an inductor L. Switches S1, S2, S3, S4, S5 may include, but are not limited to, transistors (e.g., field effect transistors (FETs), bipolar junction transistors (BJTs), insulated gate bipolar transistors (IGBTs), etc.), relays, etc. Each switch S1, S2, S3, S4, S5 includes a control terminal configured to receive control input signals. Thus, each switch S1, S2, S3, S4, S5 control terminal may be coupled to controller logic 110.

Switches S1, S2, and S5 may be operated as two-state devices (e.g., ON or OFF) and/or as linear devices (i.e., linear state) based, at least in part, on control inputs (i.e., control signals) from controller logic 110. Switches S3 and S4 may be operated as two-state devices. A switch in a linear state is configured to operate as a variable resistance, with the resistance related to the control input. For example, for metal oxide semiconductor FETs (MOSFETs), the ON state may correspond to saturation and the OFF state may correspond to cut-off. A switch in the ON state is configured to conduct current and may have an associated relatively small non-zero ON-resistance. A switch in the OFF state is configured to at least approach an open circuit in at least one direction, direction related to current flow. A switch in the OFF state may conduct a relatively small leakage current in at least one direction.

In an embodiment, switch S5 may include two switches coupled together. The two switches may be configured to prevent a current greater than a leakage current from flowing in either direction when switch S5 is in the OFF state. In some cases, a switch, e.g., a MOSFET, in the OFF state may be configured to “stop” current in one direction, i.e., only the leakage current may flow. The MOSFET may allow current flow (greater than the leakage current) in the opposite direction via, for example, a body diode. In some situations, for example when a current to be controlled has one polarity, i.e., the current flows in only one direction, one switch may be adequate to control current flow. In other situations, for example when the current to be controlled may flow in either direction, one switch may not be adequate. Thus, two switches may be coupled together to control current flow in both directions. For example, switch S5 may include two MOSFETs with respective source terminals (or drain terminals) coupled together to prevent current flow through a body diode when switch S5 is in the OFF state.

Selectable-mode VR 102 and/or one or more element(s) of selectable-mode VR 102 (i.e., S1, S2, S3, S4, S5, Cf, L and/or Cout) may be on-die or off-die. Ranges of values of elements of selectable-mode VR 102 may be related to whether the selectable-mode VR 102 and/or elements of selectable-mode VR 102 are implemented on-die, off-die or a combination. For example, if the selectable-mode VR 102 is implemented on-die, capacitance of flying capacitor Cf may be on the order of nanofarads (nF) and the inductance of inductor L may be on the order of nanohenries (nH). In another example, if the selectable-mode VR 102 is implemented off-die, the capacitance of Cf may be on the orders of microfarads (μF) or millifarads (mF) and the inductance of L may be on the orders of hundreds of nH or tens of microhenries (μH). Element values and/or types may further be related to capacity (i.e., output power) of the selectable-mode VR 102. Values of the elements of selectable-mode VR 102 may be further related to a range of switching frequency Fs. For example, types (i.e., values) of elements that may be available may vary with operating frequency range.

Turning to the selectable-mode VR 102 topology, a first terminal of switch S1 is coupled to a supply voltage source Vcc, a second terminal of switch S1 is coupled to a first terminal of switch S2 and a first terminal of flying capacitor Cf. A second terminal of switch S2 is coupled to a VSW node 104, a first terminal of inductor L, a first terminal of switch S5 and a first terminal of switch S3. A second terminal of switch S3 is coupled to a second terminal of flying capacitor Cf and a first terminal of switch S4. A second terminal of switch S4 is coupled to ground. A second terminal of switch S5 is coupled to a second terminal of inductor L, a first terminal of output capacitor Cout and selectable-mode VR output Vout. A second terminal of capacitor Cout is coupled to ground.

Selectable-mode VR 102 may be configured as one or more VR modes (i.e., VR topologies) based, at least in part, on control of one or more of switches S1, S2, S3, S4, S5 and resulting switch S1, S2, S3, S4, S5 states. Based, at least in part, on selected switch states, flying capacitor Cf and/or inductor L may (or may not) affect operation of selectable-mode VR 102 configured as a selected VR mode, as described herein. The VR modes include linear (including low drop out (LDO)) VR mode, traditional (i.e., classic) buck VR mode, three-level buck VR mode and/or switched capacitor VR mode. In an embodiment, a plurality of modes may be combined using the selectable-mode VR 102 topology, as described herein.

In an embodiment, the selectable-mode VR 102 may be configured as one or more linear VR modes, i.e., one or more linear VR modes may be selected and implemented. Selection criteria of a specific linear mode VR may include consideration of one or more physical characteristics (e.g., whether an element of selectable-mode VR 102 is located on-die or off-die) of selectable-mode VR 102. When the selectable-mode VR 102 is configured as a linear VR, switches S3 and S4 are in the OFF state and may remain in the OFF state, effectively decoupling capacitor Cf. Switches S3 and S4 and flying capacitor Cf may thus not participate in the operation of selectable-mode VR 102 when the selected mode corresponds to a linear VR mode. S5 includes two switches configured to prevent current greater than a leakage current from flowing in either direction through switch S5, as described herein.

In a first linear VR mode, S5 is in the OFF state and is configured to remain in the OFF state. One or both of switch(es) S1 and/or S2 may be controlled to be in a respective linear state. The switch S1 or S2 not in the linear state may be in the ON state. The output voltage Vout may then be maintained at a target value for a varying load current by adjusting the variable resistanc(es) associated with switch(es) S1 and/or S2 operating in respective linear states. The resistanc(es) may be adjusted based, at least in part, on control input signal(s) to switches S1 and/or S2. The control input signals may be provided by controller logic 110. Controller logic 110 may be configured to adjust the switch S1 and/or S2 resistances based, at least in part, on a sensed load current and/or output voltage Vout. Inductor L and output capacitor Cout may then operate as a low pass filter.

In a second linear VR mode, S5 is in the ON state. Similar to the first linear VR mode, one or both of switch(es) S1 and/or S2 may be controlled to be in a respective linear state and the switch S1 or S2 not in the linear state may be in the ON state. The output voltage Vout may be maintained at target value for a varying load current based, at least in part, on control input signal(s) to switch(es) S1 and/or S2. In this second linear VR mode, S5 in the ON state may generally reduce or eliminate effects of inductor L since a resistance of a switch in the ON state is relatively small. An ON resistance of S5 and capacitor Cout may then operate as a low pass filter.

In a third linear VR mode, switches S1 and S2 are in the ON state and S5 may be operated in a linear state. S5 may thus provide a variable resistance in parallel with inductor L. Vout may then be maintained at a target voltage for a varying load current by adjusting the resistance of switch S5. Controller logic 110 may be configured to adjust the switch S5 resistance based, at least in part on a sensed load current. In some instances, operation of the third linear VR mode may be affected by non-ideal characteristics of inductor L. For example, a non-zero resistance of inductor L in parallel with the variable resistance of S5 may affect operation of the third linear VR mode. Such non-ideal characteristics may be considered when selecting a linear VR mode for selectable-mode VR 102.

In some embodiments, the third linear VR mode may be combined with a switched capacitor VR mode by controlling the states of switches S1, S2, S3 and S4 (ON and/or OFF), as described herein. The combination may then correspond to a switched capacitor VR mode (including switches S1, S2, S3 and S4) followed by a linear VR mode that includes switch S5 operating in the linear mode. The combination may provide enhanced efficiency by decreasing a voltage at VSW node 104 since linear VRs may generally be more efficient when a difference between input voltage and output voltage is relatively small. Further, switch S5 operating in the linear mode may reduce oscillation related to inductor L.

A specific linear VR mode may be selected based, at least in part, on one or more physical characteristics of selectable-mode VR 102. Differences in physical characteristics (e.g., electrical (e.g., parasitic capacitances, resistances, and/or inductances), thermal, etc.) between on-die and off-die may be considered when selecting, for example, a specific linear VR mode. For example, the first linear VR mode may be selected for a selectable-mode VR 102 implemented on-die. In another example, the second linear VR mode may be selected when inductor L is off-die. In this second example, S5 in the ON state may reduce effects of routing parasitics associated with conductive paths (e.g., traces) coupling inductor L to VSW node 104 and output capacitor Cout.

Thus, a selectable-mode VR 102 may be configured as a linear mode VR. A specific linear VR mode may be selected based, at least in part, on operational characteristics and/or physical characteristics associated with a specific application. A selectable-mode VR, consistent with the present disclosure may facilitate such an application-specific selection. A VR mode selection may be changed based, at least in part, on operational characteristics (e.g., Vout and/or Iout), for example, in response to an operational characteristics change or in anticipation of a change in operational characteristics. The VR mode selection change may be implemented by adjusting control input(s) to one or more of switches S1, S2, S3, S4, S5 and efficiency may be maintained and/or improved.

Generally, for traditional buck, 3-level buck and switched capacitor VR modes, each switch S1, S2, S3, S4 and/or S5 is controlled to be ON or OFF. In other words, the switches S1, S2, S3, S4, S5 are generally not operated in a linear mode for these VR modes. One or more of the switch(es) S1, S2, S3, S4, S5 is controlled by, e.g., controller logic 110, to be ON or OFF for at least a portion of a control input signal period Ts. The control input signal period Ts may thus, include one or more state intervals T1, T2, . . . , Tn. Each state interval T1, T2, . . . , Tn corresponds to a respective portion of the control input signal period Ts. Switch states are fixed during a state interval and may change at state interval boundaries. A duration of a state interval corresponds to the portion of the control input signal period in which the switch states are fixed. State intervals T1, T2, . . . , Tn may thus be utilized to describe control inputs to the selectable-mode VR 102 when the selected VR mode corresponds to traditional buck, 3-level buck and/or switched capacitor VR modes.

In an embodiment, selectable-mode VR 102 may be configured as a traditional buck VR, i.e., the traditional buck VR mode is selected. A buck VR is configured to provide an output voltage Vout less than a source voltage (Vcc) and an output current greater than an input current. In this embodiment, switch S5 is in the OFF state and remains in the OFF state. Switches S1, S2, S3 and S4 may then be controlled by, e.g., controller 110, as two-state devices. The control input signal for the traditional buck VR mode may include two state intervals, T1 and T2. In the first state interval T1, switches S1 and S2 are ON and switches S3 and S4 are OFF. In the second state interval T2, switches S1 and S2 are OFF and switches S3 and S4 are ON. VSW node 104 may then be coupled to Vcc by switches S1 and S2 during T1 and coupled to ground by switches S3 and S4 during T2. The capacitor Cf may not affect operation of selectable-mode VR 102 configured as a traditional buck VR. For example, Cf may discharge over time via a discharge path that includes switch S2, inductor L, capacitor Cout and a body diode of switch S4 and may then remain discharged.

When the VR mode of selectable-mode VR 102 is traditional buck, a control mode may correspond to PWM mode and/or a variable frequency mode. The control mode is related to a controller response to a difference between a sensed Vout and a target Vout and/or a difference between a sensed Iout and a target Iout. Target Vout and target Iout correspond to set (i.e., design) values.

Generally, in the PWM mode, the control input signal to the switches S1, S2, S3 and S4 corresponds to a PWM signal. The duty cycle of PWM signal is adjusted in response to differences between the sensed Vout and/or Iout and the corresponding target values. In other words, relative durations of state intervals may be adjusted in response to differences between the sensed Vout and/or Iout and the corresponding target values.

Generally, in the variable frequency mode, the frequency Fs of the control input signal is adjusted in response to differences between the sensed Vout and/or Tout and the corresponding target values. Variable frequency mode may include, but is not limited to, pulse skipping mode, hysteresis mode, etc. In the hysteresis mode, a window, e.g., a voltage window, is defined related to a target value, e.g., ±ΔV is defined for the target Vout. The controller is then configured to respond (i.e., control the switches S1, S2, S3 and S4 to change state) when the sensed Vout increases to greater than the target Vout+ΔV or when the sensed Vout decreases to less than the target Vout−ΔV. Respective durations of the state intervals may vary based, at least in part, on an amount of energy drawn from the selectable-mode VR 102.

Thus, in the PWM mode, switching frequency Fs may be fixed and the duty cycle may vary (i.e., the relative durations of state intervals may vary while maintaining Ts). In the variable frequency mode, the switching frequency may vary (i.e., a respective duration of each state interval may vary). Selection of the PWM mode or the variable frequency mode for operation of the selectable-mode VR 102 configured as a traditional buck VR may be based, at least in part, on a range of load currents drawn by load device 140. For example, for a relatively large load current, PWM mode may be selected and for a relatively small load current, variable frequency mode may be selected.

For example, when the selectable-mode VR 102 is configured as a buck VR and in hysteresis mode, a voltage window (e.g., ±ΔV) may be defined about the target output voltage Vtarget. In operation, initially switches S1 and S2 may be in the ON state, switches S3 and S4 may be in the OFF state (i.e., state interval T1), thus coupling VSW node 104 to Vcc. Vout may be less than Vtarget+ΔV and may be increasing. When Vout reaches Vtarget+ΔV, switches S1 and S2 may turn OFF, switches S3 and S4 may turn ON (i.e., state interval T2) thus, decoupling VSW node 104 from Vcc and coupling VSW node 104 to ground. Vout may then begin to decrease. When Vout reaches Vtarget−ΔV, switches S1 and S2 may again turn ON, switches S3 and S4 may again turn OFF and Vout may again increase. Thus, in hysteresis mode, the durations of the respective state intervals T1, T2 may be related to an amount of energy being drawn from the traditional buck VR. For example, if a relatively larger current is being drawn, then the switches S1, S2, S3 and S4 may be configured to change state at a relatively higher rate (i.e., frequency) and the durations of the state intervals T1, T2 may be relatively shorter. If a relatively smaller current is being drawn, then the switches S1, S2, S3 and S4 switching frequency is relatively lower and the durations of the state intervals T1, T2 may be relatively longer. Thus, switching frequency may vary with load in the hysteresis mode.

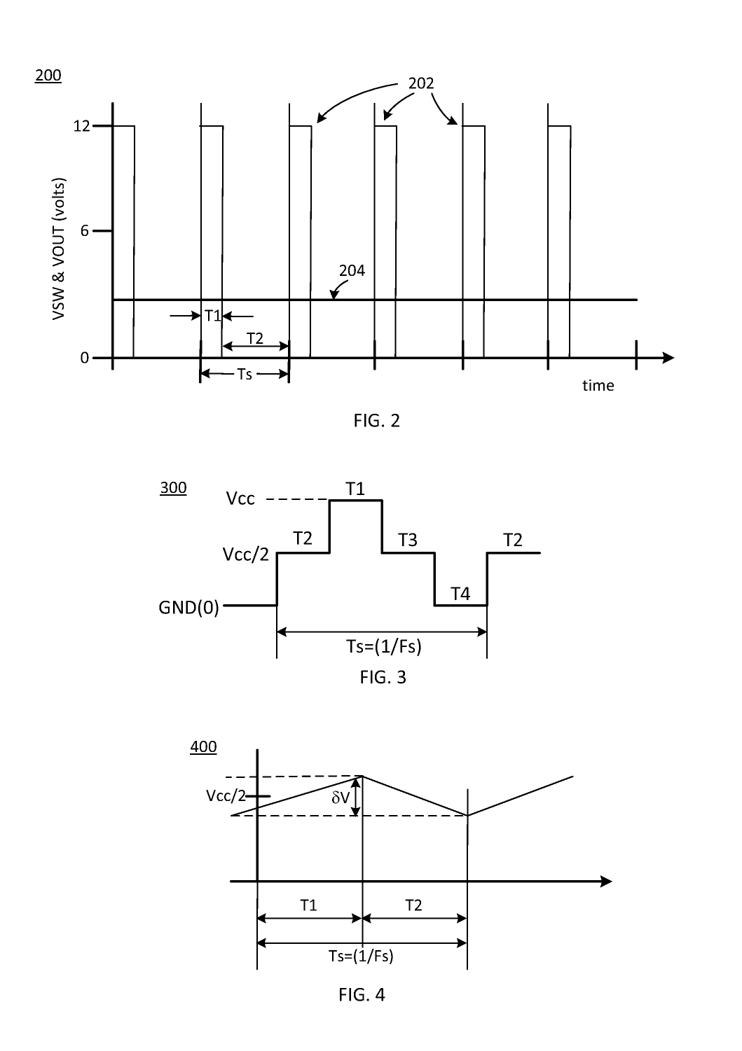

FIG. 2 is a plot 200 of VSW node voltage 202 and output voltage Vout 204 simulation results corresponding to the selectable-mode VR 102 configured as a traditional (classic) buck VR. The VSW node voltage 202 corresponds to a voltage at VSW note 104 of FIG. 1. The output voltage Vout 204 corresponds to Vout of FIG. 1. Plot 200 corresponds to the traditional buck VR driven by a PWM control input with duty cycle D less than 0.5, e.g., approximately 0.33. In this example, switch S5 is always OFF, switches S1 and S2 are ON and switches S3 and S4 are OFF during state interval T1. Switches S1 and S2 are OFF and switches S3 and S4 are ON during state interval T2. Thus, the VSW node voltage 202 may be at or near Vcc (e.g., 12 volts) during state interval T1 and at or near zero (i.e., ground) during state interval T2. The output voltage Vout 204 is maintained constant as about 3 (three) volts in this simulation example, illustrating the relation D=Vout/Vcc.

Thus, the traditional buck VR mode may be selected and a selectable-mode VR 102 may be configured as a traditional buck VR. The traditional buck VR configuration may be controlled in a PWM mode and/or a variable frequency mode, as described herein.

In an embodiment, a three-level buck VR mode may be selected and selectable-mode VR 102 may be configured as a three-level buck VR. In a three-level buck VR mode, switch S5 is in the OFF state and remains in the OFF state. Controller logic 110 may be configured to control switches S1, S2, S3 and S4 as two-state devices, similar to the traditional buck VR mode described herein. The capacitor Cf may affect operation of selectable-mode VR 102 configured as a three-level buck VR, unlike the traditional buck VR mode described herein.

FIG. 3 illustrates a VSW waveform 300 associated with VSW node 104 of FIG. 1 for a selectable-mode VR configured as a 3-level buck VR. FIG. 3 may be best understood when viewed in combination with Table 1. Waveform 300 and Table 1 illustrate four possible state intervals T1, T2, T3 and T4 and node VSW 104 and flying capacitor Cf voltages for a time period Ts. Table 1 further includes switch S1, S2, S3 and S4 states associated with each respective state interval T1, T2, T3 and T4. Ts corresponds to one period (i.e., Ts=1/Fs) of a control input signal, e.g., from controller logic 110, and is thus the period of the voltage waveform 300 at VSW node 104.

TABLE 1

| | Switch/voltage | | | | | |
|---|---|---|---|---|---|---|
| State Interval | S1 | S2 | S3 | S4 | VSW | VCf |
| T1 | ON | ON | OFF | OFF | Vcc | — |
| T2 | ON | OFF | ON | OFF | Vcc/2 | Vcc/2 |
| T3 | OFF | ON | OFF | ON | Vcc/2 | Vcc/2 |
| T4 | OFF | OFF | ON | ON | Ground (0) | — |

Table 1 illustrates possible switch states for the selectable-mode VR topology 102 configured as a three-level buck VR. Fewer than all of the switch states may be utilized to implement the three-level buck VR mode. An order of the state intervals T1, T2, T3 and/or T4 may or may not correspond to the order shown in Table 1 when implementing a three-level buck VR mode. The switch S1, S2, S3, S4 states associated with state intervals T2 and T3 correspond to voltage at VSW node 104 at or near Vcc/2. Thus, voltage waveform 300 is one example of one cycle Ts that includes the four possible states of switches S1, S2, S3, S4.

Flying capacitor Cf may be and may remain balanced when the switching period Ts includes a same number of state interval T2 as number of state interval T3. As used herein, balanced means that the voltage across the flying capacitor Cf is maintained at or near Vcc/2±δV where δV is a relatively small voltage deviation, generally within ±5%, from the nominal Vcc/2. Balance may be achieved by adjusting the duration of intervals of T2 & T3 such that the charge delivered to the flying capacitor Cf during T2 is nearly equal to the charge drawn from the capacitor during interval T3 over a given switching period Ts. In general, balanced operation of Cf may provide benefit in reducing current ripple across the inductor L and hence reduced voltage ripple at Vout.

State intervals ordered as illustrated in FIG. 3, (i.e., T2, T1, T3, T4) may be further configured to aid in maintaining fly capacitance voltage VCf balanced and at or near Vcc/2.

In operation, all or fewer than all of the state intervals T1, T2, T3 and T4 may be implemented for the selectable-mode VR 102 configured as a 3-level buck VR. Order of the state intervals T1, T2, T3, T4 in a control input signal period Ts may vary and one state interval may be included more than once in the control input signal period. In a first example, for an output voltage between zero and Vcc/2, state intervals in one period Ts may include T2, T4, T3 and T4. T1 may not be used in this first example. The duty cycle in this first example may be determined based, at least in part, on a ratio of the output voltage Vout to the source voltage Vcc, similar to the buck VR mode. In a second example, for an output voltage between Vcc/2 and Vcc, the state intervals in one period may include T1, T2, T1, T3. T4 may not be used in this second example.

When a three-level buck VR mode is selected for the selectable-mode VR 102, flying capacitor Cf may charge to Vcc/2 and act as an additional voltage source during state intervals T2 and T3. During state intervals T1 and T4, the flying capacitor Cf may not be participating in operation of the three-level buck VR since one terminal may be decoupled by switches S3 and S4 in the OFF state or by switches S1 and S2 in the OFF state, respectively. Similar to the traditional buck VR mode described herein, the selectable-mode VR 102 configured as a three-level buck VR may be controlled by a PWM and/or variable frequency, e.g., hysteresis, control input signal. The control mode (i.e., PWM mode or variable frequency mode) may be adjusted based, at least in part, on load conditions, to increase converter efficiency. For example, a variable frequency control mode may be selected for relatively low load current. In another example, a PWM control mode may be selected for relatively high load current. The output voltage Vout may be maintained at or near a target value by setting and/or adjusting the duty cycle in the PWM mode, similar to the traditional buck VR. The selectable-mode VR 102 configured as a three-level buck VR may provide a reduced switching frequency (Fs) loss for a same inductor L inductance and/or may include an inductor L with a relatively smaller inductance for a same switching frequency compared to the selectable-mode VR 102 configured as a traditional buck VR.

Thus, a three-level buck VR mode may be selected and a selectable-mode VR 102 may be configured as a three-level buck VR. The three-level buck VR configuration may be controlled in a PWM mode and/or a variable frequency, e.g., hysteresis, mode, as described herein. When controlled in a PWM mode, the output voltage Vout may be controlled to a target value based, at least in part, on duty cycle, similar to the traditional buck VR, as described herein.

In an embodiment, a switched capacitor VR mode may be selected and selectable-mode VR 102 may be configured as a switched capacitor VR. In a switched capacitor VR mode, switch S5 is in the ON state and remains in the ON state. Thus, the output capacitor Cout is continuously coupled to the VSW node 104. The inductor L is then coupled in parallel to an ON resistance associated with switch S5. The inductor L may then provide a relatively small amount of filtering of ripple that may be present in the voltage detected at VSW node 104.

FIG. 4 illustrates a Vout waveform 400 for the selectable-mode VR 102 configured as a switched capacitor VR. Controller logic 110 may be configured to control switches S1, S2, S3 and S4 as two-state devices. The control input signal period Ts may include two state intervals T1 and T2 (i.e., Ts=T1+T2) in the switched capacitor VR mode. In the first state interval T1, switches S1 and S3 are ON, switches S2 and S4 are OFF and VSW node 104 voltage and flying capacitor Cf voltage are both at or near Vcc/2. In the second state interval T2, switches S1 and S3 are OFF, switches S2 and S4 are ON and VSW node 104 voltage and flying capacitor Cf voltage are both at or near Vcc/2. In the first state interval T1, VSW node 104 is coupled to supply voltage Vcc through flying capacitor Cf by switches S1 and S3. In the second state interval T2, VSW node 104 is coupled to ground through flying capacitor Cf by switches S2 and S4. Thus, during the first state interval T1, the voltage detected at VSW node 104 may increase and during the second state interval T1, the voltage detected at VSW node 104 may be decrease. The flying capacitor Cf may charge to at or near Vcc/2 in both state intervals T1, T2 (similar to the three-level buck VR mode, as described herein). The Vout waveform 400 exhibits ripple δV over the control input signal period Ts. Vout may thus vary between Vcc/2+δV and Vcc/2−δV.

For a selectable-mode VR 102 configured as a switched capacitor VR, the output voltage Vout may be controlled by varying Fs (i.e., the frequency of the control input signal). In other words, when the selectable-mode VR 102 is configured as a switched capacitor VR, the control mode may correspond to a variable frequency mode. In some embodiments, the duty cycle of the control input signal to the switched capacitor mode VR may be fixed. For example, the duty cycle may be 0.5. In some embodiments, the duty cycle may be varied by, e.g., controller logic 110.

A selectable-mode VR 102 configured as a switched capacitor VR may be modeled as an ideal 2:1 transformer coupled to a series resistance. Thus, for the selectable-mode VR 102 configured as a switched capacitor VR and operated near an ideal transformation ratio, for example, 2:1, the series resistance component coupled to the ideal transformer is relatively very small resulting in a relatively very high efficiency. This characteristic is similar to a conventional switched capacitor VR.

Thus, the selectable-mode VR 102 may be configured as a switched capacitor VR. The output voltage may be controlled by varying the control input signal frequency Fs.

Thus, a selectable-mode VR may be configured to implement one or more of a plurality of VR modes, e.g., linear (e.g., low drop out), traditional (i.e., classic) buck, three-level buck and/or switched capacitor. A selectable-mode VR topology system and method are configured to allow selecting a specific mode prior to and/or during operation of the selectable-mode VR. The mode may be selected based, at least in part, on one or more of anticipated load, existing load, a signal from a load device that includes a load and/or sensed current and/or voltage. The specific mode may be selected to optimize the VR topology and/or one or more performance characteristics for existing and/or anticipated operating conditions.

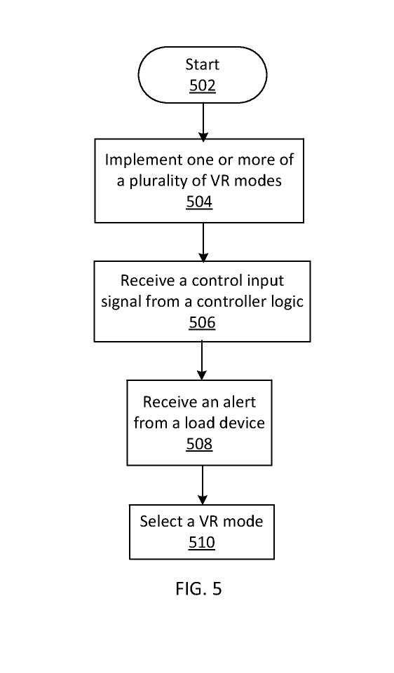

FIG. 5 is a flowchart 500 of selectable-mode voltage regulation operations according to various embodiments of the present disclosure. In particular, the flowchart 500 illustrates operation of a selectable-mode VR. The operations may be performed, for example, by the selectable-mode VR 102 of FIG. 1.

Operations of this embodiment may begin with start 502. Operation 504 includes implementing, by a selectable-mode voltage regulator (VR), one or more of a plurality of VR modes. Operation 506 may include receiving a control input signal from a controller logic. For example, the control input signal may be received by one or more switches included in the selectable-mode VR. Operation 508 may include receiving an alert from a load device. The alert may be related to anticipated power consumption of the load device. Operation 510 may include selecting a VR mode. For example, the VR mode may be selected by mode selection logic. The mode selection may be based, at least in part, on the alert from the load device. Thus, one or more of a plurality of VR modes may be implemented by a selectable-mode VR, consistent with the present disclosure.

While the flowchart of FIG. 5 illustrates operations according various embodiments, it is to be understood that not all of the operations depicted in FIG. 5 are necessary for other embodiments. In addition, it is fully contemplated herein that in other embodiments of the present disclosure, the operations depicted in FIG. 5, and/or other operations described herein may be combined in a manner not specifically shown in any of the drawings, and such embodiments may include less or more operations than are illustrated in FIG. 5. Thus, claims directed to features and/or operations that are not exactly shown in one drawing are deemed within the scope and content of the present disclosure.

Memory 122 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The logic may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Load device 140 may be configured to implement one or more device configuration and/or power management operations. Such device configuration and/or power management operations may comply and/or be compatible with Advanced Configuration and Power Interface Specification, Revision 5.1, published by the Unified Extensible Firmware Interface (UEFI) Forum, Beaverton, Oreg., July 2014, and/or earlier and/or later and/or related versions of this specification.

In some embodiments, a hardware description language (HDL) may be used to specify circuit and/or logic implementation(s) for the various logic and/or circuitry described herein. For example, in one embodiment the hardware description language may comply or be compatible with a very high speed integrated circuits (VHSIC) hardware description language (VHDL) that may enable semiconductor fabrication of one or more circuits and/or logic described herein. The VHDL may comply or be compatible with IEEE Standard 1076-1987, IEEE Standard 1076.2, IEEE1076.1, IEEE Draft 3.0 of VHDL-2006, IEEE Draft 4.0 of VHDL-2008 and/or other versions of the IEEE VHDL standards and/or other hardware description standards.

Thus, consistent with the teachings of the present disclosure, a selectable-mode VR may be configured to implement one or more of a plurality of VR modes, e.g., linear (e.g., low drop out), traditional (i.e., classic) buck, three-level buck and/or switched capacitor. A selectable-mode VR topology system and method are configured to allow selecting a specific mode prior to and/or during operation of the selectable-mode VR. The mode may be selected based, at least in part, on one or more load characteristics. Load characteristics may include an anticipated load, existing load, a signal from a load device that includes a load and/or sensed current and/or voltage. The specific mode may be selected to optimize one or more performance characteristics the VR topology for existing and/or anticipated operating conditions.

### EXAMPLES

Examples of the present disclosure include subject material such as a method, means for performing acts of the method, a device, or of an apparatus or system related to a selectable voltage regulator topology, as discussed below.

### Example 1

According to this example there is provided an apparatus. The apparatus includes a selectable-mode voltage regulator (VR) to implement one or more of a plurality of VR modes. The selectable-mode VR includes a plurality of switches, an inductor (L), a flying capacitor (CO, and an output capacitor (Cout).

### Example 2

This example includes the elements of example 1, wherein the plurality of switches includes a first switch (S1), a second switch (S2), a third switch (S3), a fourth switch (S4) and a fifth switch (S5). A first terminal of S1 is to couple to a supply voltage source Vcc, a second terminal of S1 is coupled to a first terminal of S2 and a first terminal of Cf, a second terminal of S2 is coupled to a first terminal of L, a first terminal of S5 and a first terminal of S3, a second terminal of S3 is coupled to a second terminal of Cf and a first terminal of S4, a second terminal of S4 is to couple to ground, a second terminal of S5 is coupled to a second terminal of L, a first terminal of Cout and selectable-mode VR output Vout, and a second terminal of Cout is to couple to ground.

### Example 3

This example includes the elements of example 1, wherein the plurality of VR modes includes a linear VR mode, a low drop out VR mode, a traditional buck VR mode, a three-level buck VR mode, a switched capacitor VR mode and a combination of a switched capacitor VR mode followed by a linear VR mode.

### Example 4

This example includes the elements according to any one of examples 1 to 3, wherein at least one of the plurality of switches is to receive a control input signal from a controller logic.

### Example 5

This example includes the elements of example 4, wherein the control input signal corresponds to a pulse width modulated (PWM) control mode.

### Example 6

This example includes the elements of example 4, wherein the control input signal corresponds to a variable frequency control mode.

### Example 7

This example includes the elements of example 2, wherein S5 includes two switches coupled together.

### Example 8

This example includes the elements according to any one of examples 1 to 3, wherein at least one of the plurality of switches is selected from the group including field effect transistors (FETs), bipolar junction transistors (BJTs), insulated gate bipolar transistors (IGBTs) and relays.

### Example 9

This example includes the elements according to any one of examples 1 to 3, wherein the one or more VR mode(s) is implemented in response to a selection by controller logic.

### Example 10

This example includes the elements according to any one of examples 1 to 3, wherein each of the plurality of switches includes a control terminal to receive control input signals.

### Example 11

This example includes the elements of example 2, wherein switches S1, S2 and S5 are operated as one or more of two-state devices and linear devices and switches S3 and S4 are operated as two-state devices.

### Example 12

This example includes the elements of example 7, wherein the two switches are transistors.

### Example 13

This example includes the elements of example 2, wherein the selectable-mode VR is configured as a linear VR mode, S3 and S4 are in an OFF state and S5 includes two switches coupled together.

### Example 14

This example includes the elements of example 13, wherein S5 is in an OFF state, at least one of S1 and S2 is in a linear state.

### Example 15

This example includes the elements of example 14, wherein S1 or S2 is in an ON state.

### Example 16

This example includes the elements of example 13, wherein S1 and S2 are in an ON state and S5 is in a linear state.

### Example 17

This example includes the elements of example 2, wherein the selectable-mode VR is configured as a combination switched capacitor VR mode followed by a linear VR mode.

### Example 18

This example includes the elements of example 17, wherein switches S1, S2, S3 and S4 are operated as two-state devices and S5 is operated in a linear state.

### Example 19

This example includes the elements of example 2, wherein the selectable-mode VR is configured as a traditional buck VR mode, a 3-level buck VR mode or a switched capacitor VR mode and S1, S2, S3, S4 and S5 are operated as two-state devices, a respective state entered in response to a control signal.

### Example 20

This example includes the elements of example 19, wherein a control mode corresponds to a variable frequency mode.

### Example 21

This example includes the elements of example 19, wherein a control mode corresponds to a pulse width modulated (PWM) control mode.

### Example 22

This example includes the elements of example 19, wherein the selectable-mode VR is configured as the traditional buck VR, S5 is in an OFF state, S1 and S2 are ON and S3 and S4 are OFF during a first state interval and S1 and S2 are OFF and S3 and S4 are ON during a second state interval.

### Example 23

This example includes the elements of example 19, wherein the selectable-mode VR is configured as the 3-level buck VR, S5 is in an OFF state, S1 and S2 are ON and S3 and S4 are OFF during a first state interval, S1 and S3 are ON and S2 and S4 are OFF during a second state interval, S2 and S4 are ON and S1 and S3 are OFF during a third state interval, S3 and S4 are ON and S1 and S2 are OFF during a fourth state interval and at least some of the plurality of state intervals are selected in response to the control signal.

### Example 24

This example includes the elements of example 19, wherein the selectable-mode VR is configured as a switched capacitor VR, S5 is in an ON state, S1 and S3 are ON and S2 and S4 are OFF during a first state interval, S1 and S3 are OFF and S2 and S4 are ON during a second state interval.

### Example 25

According to this example, there is provided a method. The method includes implementing, by a selectable-mode voltage regulator (VR), one or more of a plurality of VR modes, the selectable-mode VR including a plurality of switches, an inductor (L), a flying capacitor (CO, and an output capacitor (Cout).

### Example 26

This example includes the elements of example 25, wherein the plurality of switches includes a first switch (S1), a second switch (S2), a third switch (S3), a fourth switch (S4) and a fifth switch (S5). A first terminal of S1 is to couple to a supply voltage source Vcc, a second terminal of S1 is coupled to a first terminal of S2 and a first terminal of Cf, a second terminal of S2 is coupled to a first terminal of L, a first terminal of S5 and a first terminal of S3, a second terminal of S3 is coupled to a second terminal of Cf and a first terminal of S4, a second terminal of S4 is to couple to ground, a second terminal of S5 is coupled to a second terminal of L, a first terminal of Cout and selectable-mode VR output Vout, and a second terminal of Cout is to couple to ground.

### Example 27

This example includes the elements of example 25, wherein the plurality of VR modes includes a linear VR mode, a low drop out VR mode, a traditional buck VR mode, a three-level buck VR mode, a switched capacitor VR mode and a combination of a switched capacitor VR mode followed by a linear VR mode.

### Example 28

This example includes the elements of example 25, further including receiving, by at least one switch, a control input signal from a controller logic.

### Example 29

This example includes the elements of example 28, wherein the control input signal corresponds to at least one of a pulse width modulated (PWM) control mode and/or a variable frequency control mode.

### Example 30

This example includes the elements of example 25, further including selecting, by mode selection logic, a VR mode.

### Example 31

This example includes the elements of example 30, wherein the VR mode is selected, based at least in part, on a load characteristic.

### Example 32

This example includes the elements of example 25, further including receiving, by device interface logic, an alert from a load device.

### Example 33

This example includes the elements of example 30, wherein the VR mode is selected at least one of prior to and/or during operation of the selectable-mode VR.

### Example 34

This example includes the elements of example 31, wherein the load characteristic includes one or more of an anticipated load, an existing load, a signal from a load device that includes a load, a sensed current and/or a sensed voltage.

### Example 35

This example includes the elements of example 30, wherein the selected VR mode is to optimize a performance characteristic.

### Example 36

This example includes the elements of example 30, wherein the VR mode is selected based, at least in part, on optimizing a performance characteristic.

### Example 37

This example includes the elements of example 35, wherein the performance characteristic includes one or more of a conversion efficiency, an output voltage ripple, an output current ripple and/or a transient performance.

### Example 38

This example includes the elements of example 30, wherein the VR mode is selected in response to a change in operating conditions.

### Example 39

This example includes the elements of example 30, wherein the VR mode is selected based, at least in part, on an anticipated change in operating conditions.

### Example 40

This example includes the elements of example 30, wherein the VR mode is selected based, at least in part, on a notification of an anticipated change in operating conditions.

### Example 41

This example includes the elements of example 38, wherein the operating conditions include one or more of a load voltage and/or load current.

### Example 42

This example includes the elements of example 32, wherein the alert is related to at least one of existing power consumption and/or anticipated changes in power consumption of the load device.

### Example 43

This example includes the elements of example 25, further including, monitoring by controller logic, one or more load characteristics.

### Example 44

This example includes the elements of example 43, wherein the load characteristics include one or more of an output voltage and/or an output current.

### Example 45

This example includes the elements of example 43, further including selecting, by the controller logic, a VR mode of the selectable-mode VR based, at least in part, on the one or more load characteristics.

### Example 46

This example includes the elements of example 32, further including storing, by the device interface logic, an alert indicator associated with the alert in a parameter and policy store.

### Example 47

This example includes the elements of example 30, wherein the VR mode is selected based, at least in part, on a policy indicator.

### Example 48

This example includes the elements of example 25, further including controlling, by VR control logic, operations of the selectable-mode VR.

### Example 49

This example includes the elements of example 30, wherein the VR mode is selected dynamically, during operation of the selectable-mode VR.

### Example 50

This example includes the elements of example 25, further including generating, by control input signal (CIS) logic, a control input signal to drive one or more of the switches.

### Example 51

This example includes the elements of example 50, wherein the control input signal includes at least one of a pulse width modulated signal and a variable frequency signal.

### Example 52

This example includes the elements of example 51, wherein the variable frequency signal corresponds to a hysteresis control mode.

### Example 53

This example includes the elements example 26, further including operating, by the controller logic, S1, S2 and S5 as one or more of two-state devices and linear devices and operating, by the controller logic, S3 and S4 as two-state devices.

### Example 54

This example includes the elements of example 26, wherein S5 includes two switches coupled together.

### Example 55

This example includes the elements of example 54, wherein the two switches are transistors.

### Example 56

This example includes the elements of example 26, further including configuring, by the controller logic, the selectable-mode VR as a linear VR mode and controlling, by the controller logic, S3 and S4 in an OFF state, and S5 includes two switches coupled together.

### Example 57

This example includes the elements of example 56, further including controlling, by the controller logic, S5 in an OFF state and controlling, by the controller logic, at least one of S1 and S2 in a linear state.

### Example 58

This example includes the elements of example 57, further including controlling, by the controller logic, S1 or S2 in an ON state.

### Example 59

This example includes the elements of example 56, further including controlling, by the controller logic, S1 and S2 in an ON state and controlling, by the controller logic, S5 in a linear state.

### Example 60

This example includes the elements of example 26, further including configuring, by the controller logic, the selectable-mode VR as a combination switched capacitor VR mode followed by a linear VR mode.

### Example 61

This example includes the elements of example 60, further including operating, by the controller logic, S1, S2, S3 and S4 as two-state devices and operating, by the controller logic, S5 in a linear state.

### Example 62

This example includes the elements of example 26, further including configuring, by the controller logic, the selectable-mode VR as a traditional buck VR mode, a 3-level buck VR mode or a switched capacitor VR mode and operating, by the controller logic, S1, S2, S3, S4 and S5 as two-state devices, a respective state entered in response to a control signal from the controller logic.

### Example 63

This example includes the elements of example 62, wherein a control mode corresponds to a variable frequency mode.

### Example 64

This example includes the elements of example 62, wherein a control mode corresponds to a pulse width modulated (PWM) control mode.

### Example 65

This example includes the elements of example 62, further including configuring, by the controller logic, the selectable-mode VR as the traditional buck VR, controlling, by the controller logic, S5 in an OFF state, controlling, by the controller logic, S1 and S2 in an ON state and S3 and S4 in an OFF state during a first state interval and controlling, by the controller logic, S1 and S2 in an OFF state and S3 and S4 in an ON state during a second state interval.

### Example 66

This example includes the elements of example 62, further including configuring, by the controller logic, the selectable-mode VR as the 3-level buck VR, controlling, by the controller logic, S5 in an OFF state, controlling, by the controller logic, S1 and S2 in an ON state and S3 and S4 in an OFF state during a first state interval, controlling, by the controller logic, S1 and S3 in an ON state and S2 and S4 in an OFF state during a second state interval, controlling, by the controller logic, S2 and S4 in an ON state and S1 and S3 in an OFF state during a third state interval, controlling, by the controller logic, S3 and S4 in an ON state and S1 and S2 in an OFF state during a fourth state interval and at least some of the plurality of state intervals are selected in response to the control signal.

### Example 67

This example includes the elements of example 62, further including configuring, by the controller logic, the selectable-mode VR as a switched capacitor VR, controlling, by the controller logic, S5 in an ON state, controlling, by the controller logic, S1 and S3 in an ON state and S2 and S4 in an OFF state during a first state interval, controlling, by the controller logic, S1 and S3 in an OFF state and S2 and S4 in an ON state during a second state interval.

### Example 68

According to this example, there is included a system. The system includes a selectable-mode voltage regulator (VR) to implement one or more of a plurality of VR modes and controller logic to manage operations of the selectable-mode VR. The selectable-mode VR includes a plurality of switches, an inductor (L), a flying capacitor (Cf), and an output capacitor (Cout).

### Example 69

This example includes the elements of example 68, wherein the plurality of switches includes a first switch (S1), a second switch (S2), a third switch (S3), a fourth switch (S4) and a fifth switch (S5). A first terminal of S1 is to couple to a supply voltage source Vcc, a second terminal of S1 is coupled to a first terminal of S2 and a first terminal of Cf, a second terminal of S2 is coupled to a first terminal of L, a first terminal of S5 and a first terminal of S3, a second terminal of S3 is coupled to a second terminal of Cf and a first terminal of S4, a second terminal of S4 is to couple to ground, a second terminal of S5 is coupled to a second terminal of L, a first terminal of Cout and selectable-mode VR output Vout, and a second terminal of Cout is to couple to ground.

### Example 70

This example includes the elements of example 68, wherein the controller logic includes mode selection logic to select a VR mode.

### Example 71

This example includes the elements of example 68, wherein the plurality of VR modes includes a linear VR mode, a low drop out VR mode, a traditional buck VR mode, a three-level buck VR mode, a switched capacitor VR mode and a combination of a switched capacitor VR mode followed by a linear VR mode.

### Example 72

This example includes the elements of example 68, wherein the controller logic includes VR control logic to provide a control input signal to the selectable-mode VR.

### Example 73

This example includes the elements of example 72, wherein the control input signal corresponds to at least one of a pulse width modulated (PWM) control mode and/or a variable frequency control mode.

### Example 74

This example includes the elements of any one of examples 68 to 72, wherein the controller logic includes device interface logic to receive an alert from a load device.

### Example 75

This example includes the elements of example 70, wherein the VR mode is selected at least one of prior to and/or during operation of the selectable-mode VR.

### Example 76

This example includes the elements of example 70, wherein the VR mode is selected, based at least in part, on a load characteristic.

### Example 77

This example includes the elements of example 76, wherein the load characteristic includes one or more of an anticipated load, an existing load, a signal from a load device that includes a load, a sensed current and/or a sensed voltage.

### Example 78

This example includes the elements of example 70, wherein the selected VR mode is to optimize a performance characteristic.

### Example 79

This example includes the elements of example 70, wherein the VR mode is selected based, at least in part, on optimizing a performance characteristic.

### Example 80

This example includes the elements of example 78 or 79, wherein the performance characteristic includes one or more of a conversion efficiency, an output voltage ripple, an output current ripple and/or a transient performance.

### Example 81

This example includes the elements of example 70, wherein the VR mode is selected in response to a change in operating conditions.

### Example 82

This example includes the elements of example 70, wherein the VR mode is selected based, at least in part, on an anticipated change in operating conditions.

### Example 83

This example includes the elements of example 70, wherein the VR mode is selected based, at least in part, on a notification of an anticipated change in operating conditions.

### Example 84

This example includes the elements of any one of examples 81 to 83, wherein the operating conditions include one or more of a load voltage and/or load current.

### Example 85

This example includes the elements of example 74, wherein the alert is related to at least one of existing power consumption and/or anticipated changes in power consumption of the load device.

### Example 86

This example includes the elements of any one of examples 68 to 72, wherein the controller logic is to monitor one or more load characteristics.

### Example 87

This example includes the elements of example 86, wherein the load characteristics include one or more of an output voltage and/or an output current.

### Example 88

This example includes the elements of example 86 or 87, wherein the controller logic is to select a VR mode of the selectable-mode VR based, at least in part, on the one or more load characteristics.

### Example 89

This example includes the elements of example 74, wherein the controller logic further includes a parameter and policy store and the device interface logic is to store an alert indicator associated with the alert in the parameter and policy store.

### Example 90

This example includes the elements of any one of examples 68 to 72, further including VR control logic to control operations of the selectable-mode VR.

### Example 91

This example includes the elements of example 70, wherein the mode selection logic is to select the VR mode based, at least in part, on a policy indicator.

### Example 92

This example includes the elements of any one of examples 68 to 72, wherein the controller logic further includes control input signal (CIS) logic, the CIS logic to generate a control input signal, the control input signal to drive one or more of the switches.

### Example 93

This example includes the elements of example 92, wherein the control input signal includes at least one of a pulse width modulated signal and a variable frequency signal.

### Example 94

This example includes the elements of example 93, wherein the variable frequency signal corresponds to a hysteresis control mode.

### Example 95

This example includes the elements of any one of examples 68 to 72, wherein at least a portion of the selectable-mode VR is on-die.

### Example 96

This example includes the elements of any one of examples 68 to 72, wherein at least a portion of the selectable-mode VR is off-die.

### Example 97

This example includes the elements of any one of examples 68 to 72, wherein the plurality of switches includes one or more of a field effect transistor (FET), a bipolar junction transistor (BJT), an insulated gate bipolar transistor (IGBTs) and a relay.

### Example 98

This example includes the elements of any one of examples 68 to 72, wherein each of the plurality of switches includes a respective control terminal to receive a respective control input signal.

### Example 99

This example includes the elements of any one of examples 68 to 72, wherein each of the plurality of switches includes a control terminal to receive control input signals.

### Example 100

This example includes the elements of example 69, wherein switches S1, S2 and S5 are operated as one or more of two-state devices and linear devices and switches S3 and S4 are operated as two-state devices.

### Example 101

This example includes the elements of example 69, wherein S5 includes two switches coupled together.

### Example 102

This example includes the elements of example 101, wherein the two switches are transistors.

### Example 103

This example includes the elements of example 69, wherein the selectable-mode VR is configured as a linear VR mode, S3 and S4 are in an OFF state and S5 includes two switches coupled together.

### Example 104

This example includes the elements of example 103, wherein S5 is in an OFF state, at least one of S1 and S2 is in a linear state.

### Example 105

This example includes the elements of example 104, wherein S1 or S2 is in an ON state.

### Example 106

This example includes the elements of example 103, wherein S1 and S2 are in an ON state and S5 is in a linear state.

### Example 107

This example includes the elements of example 69, wherein the selectable-mode VR is configured as a combination switched capacitor VR mode followed by a linear VR mode.

### Example 108

This example includes the elements of 107, wherein switches S1, S2, S3 and S4 are operated as two-state devices and S5 is operated in a linear state.

### Example 109

This example includes the elements of example 69, wherein the selectable-mode VR is configured as a traditional buck VR mode, a 3-level buck VR mode or a switched capacitor VR mode and S1, S2, S3, S4 and S5 are operated as two-state devices, a respective state entered in response to a control signal from the controller logic.

### Example 110

This example includes the elements of example 109, wherein a control mode corresponds to a variable frequency mode.

### Example 111

This example includes the elements of example 109, wherein a control mode corresponds to a pulse width modulated (PWM) control mode.

### Example 112

This example includes the elements of example 109, wherein the selectable-mode VR is configured as the traditional buck VR, S5 is in an OFF state, S1 and S2 are ON and S3 and S4 are OFF during a first state interval and S1 and S2 are OFF and S3 and S4 are ON during a second state interval.

### Example 113

This example includes the elements of example 109, wherein the selectable-mode VR is configured as the 3-level buck VR, S5 is in an OFF state, S1 and S2 are ON and S3 and S4 are OFF during a first state interval, S1 and S3 are ON and S2 and S4 are OFF during a second state interval, S2 and S4 are ON and S1 and S3 are OFF during a third state interval, S3 and S4 are ON and S1 and S2 are OFF during a fourth state interval and at least some of the plurality of state intervals are selected in response to the control signal.

### Example 114

This example includes the elements of example 109, wherein the selectable-mode VR is configured as a switched capacitor VR, S5 is in an ON state, S1 and S3 are ON and S2 and S4 are OFF during a first state interval, S1 and S3 are OFF and S2 and S4 are ON during a second state interval.

### Example 115

Another example of the present disclosure is a computer readable storage device having stored thereon instructions that when executed by one or more processors result in the following operations including the method according to any one of examples 25 to 67.

### Example 116

Another example of the present disclosure is a system including at least one device arranged to perform the method of any one of examples 25 to 67.

### Example 117

Another example of the present disclosure is a device including means to perform the method of any one of examples 25 to 67.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. An apparatus comprising:
a selectable-mode voltage regulator (VR) to implement one or more of a plurality of VR modes, the selectable-mode VR comprising:
a plurality of switches,
an inductor (L),
a flying capacitor (Cf), and
an output capacitor (Cout).

2. The apparatus of claim 1, wherein the plurality of switches comprises a first switch (S1), a second switch (S2), a third switch (S3), a fourth switch (S4) and a fifth switch (S5), and
a first terminal of S1 is to couple to a supply voltage source Vcc,
a second terminal of S1 is coupled to a first terminal of S2 and a first terminal of Cf,
a second terminal of S2 is coupled to a first terminal of L, a first terminal of S5 and a first terminal of S3,
a second terminal of S3 is coupled to a second terminal of Cf and a first terminal of S4,
a second terminal of S4 is to couple to ground,
a second terminal of S5 is coupled to a second terminal of L, a first terminal of Cout and selectable-mode VR output Vout, and
a second terminal of Cout is to couple to ground.

3. The apparatus of claim 1, wherein the plurality of VR modes comprises a linear VR mode, a low drop out VR mode, a traditional buck VR mode, a three-level buck VR mode, a switched capacitor VR mode and a combination of a switched capacitor VR mode followed by a linear VR mode.

4. The apparatus of claim 1, wherein at least one of the plurality of switches is to receive a control input signal from a controller logic.

5. The apparatus of claim 4, wherein the control input signal corresponds to a pulse width modulated (PWM) control mode.

6. The apparatus of claim 4, wherein the control input signal corresponds to a variable frequency control mode.

7. The apparatus of claim 2, wherein S5 comprises two switches coupled together.

8. The apparatus of claim 1, wherein at least one of the plurality of switches is selected from the group comprising field effect transistors (FETs), bipolar junction transistors (BJTs), insulated gate bipolar transistors (IGBTs) and relays.

9. A method comprising:
implementing, by a selectable-mode voltage regulator (VR), one or more of a plurality of VR modes, the selectable-mode VR comprising a plurality of switches, an inductor (L), a flying capacitor (CO, and an output capacitor (Cout).

10. The method of claim 9, wherein the plurality of switches comprises a first switch (S1), a second switch (S2), a third switch (S3), a fourth switch (S4) and a fifth switch (S5), and
a first terminal of S1 is to couple to a supply voltage source Vcc,
a second terminal of S1 is coupled to a first terminal of S2 and a first terminal of Cf,
a second terminal of S2 is coupled to a first terminal of L, a first terminal of S5 and a first terminal of S3,
a second terminal of S3 is coupled to a second terminal of Cf and a first terminal of S4,
a second terminal of S4 is to couple to ground,
a second terminal of S5 is coupled to a second terminal of L, a first terminal of Cout and selectable-mode VR output Vout, and
a second terminal of Cout is to couple to ground.

11. The method of claim 9, wherein the plurality of VR modes comprises a linear VR mode, a low drop out VR mode, a traditional buck VR mode, a three-level buck VR mode, a switched capacitor VR mode and a combination of a switched capacitor VR mode followed by a linear VR mode.

12. The method of claim 9, receiving, by at least one switch, a control input signal from a controller logic.

13. The method of claim 12, wherein the control input signal corresponds to at least one of a pulse width modulated (PWM) control mode and/or a variable frequency control mode.

14. The method of claim 9, further comprising selecting, by mode selection logic, a VR mode.

15. The method of claim 14, wherein the VR mode is selected, based at least in part, on a load characteristic.

16. The method of claim 9, further comprising receiving, by device interface logic, an alert from a load device.

17. A system comprising:
a selectable-mode voltage regulator (VR) to implement one or more of a plurality of VR modes, the selectable-mode VR comprising:
a plurality of switches,
an inductor (L),
a flying capacitor (Cf), and
an output capacitor (Cout); and
controller logic to manage operations of the selectable-mode VR.

18. The system of claim 17, wherein the plurality of switches comprises a first switch (S1), a second switch (S2), a third switch (S3), a fourth switch (S4) and a fifth switch (S5), and
a first terminal of S1 is to couple to a supply voltage source Vcc,
a second terminal of S1 is coupled to a first terminal of S2 and a first terminal of Cf,
a second terminal of S2 is coupled to a first terminal of L, a first terminal of S5 and a first terminal of S3,
a second terminal of S3 is coupled to a second terminal of Cf and a first terminal of S4,
a second terminal of S4 is to couple to ground,
a second terminal of S5 is coupled to a second terminal of L, a first terminal of Cout and selectable-mode VR output Vout, and
a second terminal of Cout is to couple to ground.

19. The system of claim 17, wherein the controller logic comprises mode selection logic to select a VR mode.

20. The system of claim 17, wherein the plurality of VR modes comprises a linear VR mode, a low drop out VR mode, a traditional buck VR mode, a three-level buck VR mode, a switched capacitor VR mode and a combination of a switched capacitor VR mode followed by a linear VR mode.

21. The system of claim 17, wherein the controller logic comprises VR control logic to provide a control input signal to the selectable-mode VR.

22. The system of claim 21, wherein the control input signal corresponds to at least one of a pulse width modulated (PWM) control mode and/or a variable frequency control mode.

23. The system of claim 17, wherein the controller logic comprises device interface logic to receive an alert from a load device.

24. The system of claim 19, wherein the VR mode is selected at least one of prior to and/or during operation of the selectable-mode VR.
